(19) United States
(12) Patent Application Publication
(10) Pub. No.: US 2012/0266650 A1
(43) Pub. Date: Oct. 25, 2012

(54) TYRE HAVING MULTI-LEVEL AUDIBLE WEAR INDICATORS

(75) Inventor: Antoine Paturle, Pont du Chateau (FR)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 13/516,933

(22) PCT Filed: Dec. 15, 2010
(86) PCT No.: PCT/FR10/52739

§ 371 Date: Jul. 10, 2012

(30) Foreign Application Priority Data
Dec. 18, 2009 (FR) 0959241

(51) Int. Cl. G01M 17/02

(52) U.S. Cl. 73/8

(57) ABSTRACT

In the course of the method for detecting wear of a tyre comprising a tread and exhibiting at least two predetermined thresholds Sᵢ of radial wear:
beyond each threshold Sᵢ, the tread is devised so that it comprises NEᵢ set(s) of sonic cavities associated with the threshold Sᵢ; and
for each threshold Sᵢ, Kₘᵢₙ is the minimum value of the values of kᵢ with:
kᵢ=NEᵢ/NEᵢ₋₁ when for the value of i ε [2, M], NEᵢ/NEᵢ₋₁22 1, or
kᵢ=NEᵢ₋₁/NEᵢ when for the value of i ε [2, M], NEᵢ₋₁/NEᵢ>1
for each threshold, an acoustic footprint noise emitted by the sonic cavity or cavities associated with this threshold is detected at a speed V, and
the value of the speed V for detecting the acoustic footprint noise is limited to an interval I=]Vₘᵢₙ; Vₘₐₓ] satisfying Vₘₐₓ≦kₘᵢₙ·Vₘᵢₙ.

The present invention relates to a method for detecting the wear of a tyre. It applies in particular, without being restricted thereto, to tyres for vehicles of any type, passenger vehicles or heavy goods vehicles.

As a tyre rolls on ground, its tread which is in contact with the ground wears by friction. To make it easier to monitor wear and detect overly pronounced wear, tyres are furnished with wear gauges, especially sonic gauges, allowing the user to detect several levels of wear.

For each threshold, the sonic wear gauges generate an acoustic footprint noise or acoustic footprint exhibiting notable characteristics, especially frequency characteristics. These frequency characteristics are dependent on parameters comprising, inter alia, the number of wear gauges, their geometry of installation, the speed of rotation of the tyre or else the dimensions of the tyre. Thus, for certain values of these parameters, the characteristics of the characteristic noise of the gauges associated with several thresholds are identical so that it is impossible to determine which wear threshold is attained.

The aim of the invention is to provide a method making it possible to identify in an unequivocal manner the wear threshold attained.

For this purpose, the subject of the invention is a method for detecting wear of a tyre comprising a tread and exhibiting at least two predetermined thresholds of radial wear, characterized in that:

beyond each threshold Sᵢ, the tread is devised so that it comprises NEᵢ set(s) of at least one so-called “sonic” cavity associated with the threshold Sᵢ; each cavity of each set being substantially aligned axially with each other cavity of the set; and

for each threshold Sᵢ, Kₘᵢₙ is the minimum value of the values of kᵢ for i ∈ [2, M] where M is the total number of predetermined thresholds of radial wear with:

kᵢ=NEᵢ/NEᵢ₋₁ when for the value of i ∈ [2, M], NEᵢ/NEᵢ₋₁>1, or

kᵢ=NEᵢ₋₁/NEᵢ when for the value of i ∈ [2, M], NEᵢ₋₁/NEᵢ>1

for each threshold, an acoustic footprint noise emitted by the sonic cavity or cavities associated with this threshold is detected at a speed V, and

the value of the speed V for detecting the acoustic footprint noise is limited to an interval I=]Vₘᵢₙ; Vₘₐₓ] satisfying Vₘₐₓ<kₘᵢₙ·Vₘᵢₙ.

The method according to the invention makes it possible to alert a user of the tyre and to identify the wear threshold attained whatever the values of the above-stated parameters.

In the present application, the acoustic footprint noise of each set is the sonic signature of each set. This noise can also be considered to be the acoustic footprint of each set.

Indeed, the noise emitted by the sonic cavity or cavities associated with each threshold is characteristic of this threshold, especially because of the number of cavities associated with each threshold as well as with the distribution of these cavities. In such a method, it is implicit that the number of set(s) of sonic cavity(cavities) associated with each threshold is different from the number of set(s) of sonic cavity(cavities) associated with each other threshold. In the interval I, the characteristics, especially frequency characteristics, of the noise of two different thresholds may not be identical. Thus, a single wear threshold is associated with each value of the characteristics, especially frequency characteristics, of the noise. For example, once Vₘᵢₙ has been determined and knowing kₘᵢₙ, it is possible to determine Vₘₐₓ and therefore I for unequivocal detection. Conversely, once Vₘₐₓ has been determined and knowing kₘᵢₙ, it is possible to determine Vₘᵢₙ and therefore I for unequivocal detection. For any value of V lying in the interval I, it is therefore possible to identify the wear threshold attained in an unequivocal manner. Thus, it is possible, by means of the processing unit to distinguish the attaining of each wear threshold.

The cavities associated with the various thresholds exhibit a particular shape which confers sonic properties on them, that is to say these cavities cause characteristic noise during the rolling of the worn tyre.

For each cavity associated with each threshold, this characteristic noise appears only when the tyre is worn beyond the corresponding threshold. Each cavity associated with a threshold thus forms a sonic gauge of wear beyond the said threshold.

Thus, even if the driver does not visually and regularly inspect the surface state of his tyres, he will be informed of the crossing of each threshold when, while rolling, he hears a characteristic hiss.

Preferably, a processing unit and one or more microphones are used for detecting the rolling noise, linked to the processing unit and able to detect the hiss amidst the rolling noise and to inform the driver of the wear of his tyres.

The term speed will be understood to mean the linear speed of rotation of the tyre which is substantially equal to the speed of the vehicle fitted with the tyre.

Advantageously, the acoustic footprint noise comprises several elementary frequency components of acoustic footprint, preferably forming at least part of a Dirac comb. The elementary frequency components of the acoustic footprint noise are characteristic of the noise emitted by the cavities. Thus, when each wear threshold of the tyre is attained, the acoustic footprint noise emitted by the gauges comprises several elementary frequency components distributed frequency-wise. Furthermore, such acoustic footprint noise exhibits a notable comb pattern of elementary frequency components that is unique and therefore easy to detect.

According to other optional characteristics of the method:

Each elementary frequency component of the acoustic footprint noise is distant from at least one adjacent elementary frequency component of the acoustic footprint noise by a frequency gap lying in a reference frequency interval associated with a unique threshold. For each threshold, the reference frequency interval is characteristic of this threshold. Thus, when a wear threshold is attained, the acoustic footprint noise emitted by the cavities associated with this threshold comprises several elementary frequency components distributed frequency-wise according to the predetermined pattern. The predetermined reference frequency interval corresponds to the set of the frequency gaps which may separate the elementary frequency components of the noise associated with each wear threshold. Thus, this reference frequency interval covers all the frequency gaps that may separate two elementary frequency components of the noise associated with each different wear threshold. In the interval I, the frequency gap separating two elementary frequency components of the noise is therefore associated with a single wear threshold.

The predetermined reference frequency interval lies between 1 and 300 Hz. This frequency interval comprises the frequency gap liable to separate the elementary frequency components of the noise emitted by the cavities. The reference frequency interval is determined by taking account of the extreme values of the parameters that it is desired not to have to enter or modify, for example the dimensions of the tyre. Thus, for a passenger vehicle, for a speed varying between 10 and 130 km/h, a number of gauges varying between 1 and 20 and a circumference varying between 1.30 m and 3.0 m, the frequency gap of the elementary frequency components of the noise emitted by the cavities belongs to the interval lying between 1 Hz and about 300 Hz. A similar range of frequencies holds for heavy goods vehicles travelling at speeds of less than 90 km/h, equipped with tyres with a maximum of 32 gauges and with a circumference varying between 2.1 and 3.7 m.

In one embodiment, each set consists of a single sonic cavity.

In another embodiment, each set comprises at least two cavities aligned substantially axially with one another.

In this embodiment, a cavity of a set associated with a threshold exhibits substantially the same azimuth as that of another cavity of the set associated with the same threshold. Thus, these cavities are simultaneously sonic.

In another embodiment, two axially aligned cavities are associated with two different thresholds. In this case, the two cavities do not form part of the same set.

Optionally, the sets of sonic cavity(cavities) associated with each threshold are arranged so that, beyond each threshold, the sets of sonic cavity(cavities) associated with each threshold are equi-distributed circumferentially over the tyre.

The expression “equi-distributed circumferentially” is understood to mean that each set of cavity(cavities) associated with a given threshold is situated substantially the same spatial distance from the two sets of cavity(cavities) which are adjacent to it. In the case where a single set is associated with a given threshold, this single set is also equi-distributed circumferentially. Indeed, in this case, the adjacent sets are formed by this same set.

Furthermore, in all cases, as the sets of cavity(cavities) are equi-distributed circumferentially around the tread of the tyre whatever threshold is attained, the characteristics of the noise emitted beyond each threshold are unique and notable. Thus, the noise emitted by the tyre is easily detectable amidst the rolling noise of the tyre, the wind, the noise of the engine or the noise of the drivetrain associated therewith. Indeed, the noise emitted beyond each threshold exhibits, in the frequency domain, the shape of a characteristic Dirac comb that can easily be identified amidst all the above-stated spurious noises.

The cavities will be able to be offset axially with respect to one another while being equi-distributed circumferentially around the tread.

In an optional manner, beyond each threshold, each sonic cavity emerges radially to the exterior of the tyre, and is devised so as to be closed by the ground in a substantially leaktight manner as it passes across the area of contact of the tyre with the ground.

Indeed, because each cavity is devised so as to be closed by the ground in a substantially leaktight manner, it temporarily traps air as it passes across the area of contact of the tyre with the ground. Now, under the effect of the deformation of the tyre in the contact area, this air trapped in the cavity compresses and then expands fiercely on exiting the contact area when the tread loses contact with the ground at the rear of the tyre and when consequently the cavity opens.

This expansion of the air lasts of the order of a few milliseconds and causes a specific noise, sometimes called hiss or pumping noise, dependent especially on the shape and volume of the cavity.

Given that this hiss phenomenon appears only when air is compressed in the cavity and then expanded by escaping from the cavity, it is important that this cavity be closed in a substantially leaktight manner by the ground as it passes across the contact area. Indeed, a cavity whose top were covered by the ground but which, moreover, comprised transverse channels in fluidic communication with the exterior air, would not form a sonic cavity since the air that it contains could not be compressed. This is especially the case as regards the sculptures of the treads of the tyres of the prior art which are generally formed by a network of channels through which the various cavities communicate with one another and with the exterior air.

Likewise, a cavity whose dimensions were too large to be able to be totally covered by the ground as it passes across the contact area, for example a cavity whose length were greater than the length of the contact area, could not form a sonic cavity within the meaning of the invention.

In one embodiment, kₘᵢₙ=2.

According to optional characteristics of the invention the interval I is chosen from among the following speed intervals in km/h: ]50; 100], ]60; 120] and ]65; 130].

Optionally, the tyre comprises:

at least one circumferential groove, of predetermined depth when the tyre is brand new, and

at least two ribs made transversely at the bottom of the groove, of predetermined height when the tyre is brand new, substantially equal to the difference between the predetermined depth of the groove and one of the predetermined wear thresholds,

in which the distance separating the two ribs is less than a predetermined distance so that, beyond one or each of the predetermined thresholds of radial wear, the cavity formed by the groove and delimited by the two ribs is sonic.

By disposing the cavities in the grooves, the noise emitted by the cavities is amplified with respect to sonic wear gauges which would be disposed elsewhere in the tread. The noise emitted is also amplified by a pavilion formed by the tyre and the ground once each cavity has passed the contact area. This amplification by pavilion effect is a maximum when each sonic cavity is preferably disposed axially in a central part of the contact area of the tyre.

The expression central part of the contact area is intended to mean the zone of the contact area extending axially over substantially half the width of this contact area under the nominal conditions of loading and pressure and centred in relation to the central median plane of the tyre. In one embodiment with so-called “descending” sonic pattern, kᵢ=NEᵢ/NEᵢ₋₁>1 for any value of i ∈ [2, M].

Stated otherwise, the number NEᵢ of sets of sonic cavities increases with the wear of the tyre.

In this embodiment, by increasing the number of sets and therefore the number of cavities, the total volume of the cavities can increase at each threshold. It is noted that detection of the noise emitted by the cavities is then easier as the tyre wears.

In a variant of this embodiment, each cavity associated with a given threshold is also associated with the threshold above the given threshold. This makes it possible to minimize the number of cavities appearing at each threshold. Thus, the effect of the cavities on the performance of the tyre, especially the hydro-dynamic performance, is minimized. Thus, each cavity associated with a given threshold is also associated with all the thresholds above the given threshold. This characteristic obviously does not apply to the cavities of the highest threshold.

In another variant of this embodiment, the sonic cavity or cavities associated with a given threshold do not comprise any sonic cavity associated with the threshold below the given threshold. Thus, when the given threshold is attained, the cavity or cavities associated with the threshold below the given threshold cease to be sonic. Stated otherwise, each set of cavities is strictly associated with a single wear threshold.

In another variant, the sonic cavity or cavities associated with a given threshold comprise part of the sonic cavities associated with the threshold below the given threshold and sonic cavities that have appeared beyond the given threshold. Thus, only a few sonic cavities associated with the lower threshold are also sonic cavities associated with the given threshold.

In another embodiment with so-called “ascending” sonic pattern, kᵢ=NEᵢ₋₁NEᵢ>1 for any value of i ∈ [2, M].

Stated otherwise, the number NEᵢ of sets of sonic cavities decreases with the wear of the tyre.

The sonic cavities, when they are arranged in the grooves, may degrade the performance of the tyre with respect to a tyre devoid of such sonic cavities, especially in terms of dispersal of water by the grooves. This degradation of the water dispersal performance is all the greater the more advanced the wear of the tyre. Thus, by decreasing the number of sets of sonic cavities and therefore the number of sonic cavities with the advancing of the wear of the tyre, the potential loss of performance generated by the sonic cavities is limited. On the other hand, it is preferable to provide a sufficient number of cavities so that the total volume of the cavities may be sufficiently large, especially so that it is greater than the predetermined minimum volume.

In a variant of this embodiment, the sonic cavity or cavities associated with a given threshold are no longer sonic or disappear beyond the threshold above the given threshold. The sonic cavities associated with the threshold above the given threshold are therefore solely cavities appearing beyond the threshold above the given threshold. Stated otherwise, each cavity is strictly associated with a single wear threshold.

In another variant of this embodiment, the sonic cavity or cavities associated with a given threshold comprise part of the sonic cavity or cavities associated with a threshold below the given threshold.

The subject of the invention is also a computer program, characterized in that it comprises code instructions for controlling the execution of the steps of the method such as is defined hereinabove when it is executed on a computer.

The subject of the invention is furthermore a medium for recording data comprising, in recorded form, a program such as defined hereinabove.

Another subject of the invention is making available of a program such as defined hereinabove on a telecommunication network with a view to its downloading.

The invention will be better understood on reading the description which follows, given solely by way of nonlimiting example and while referring to the drawings in which:

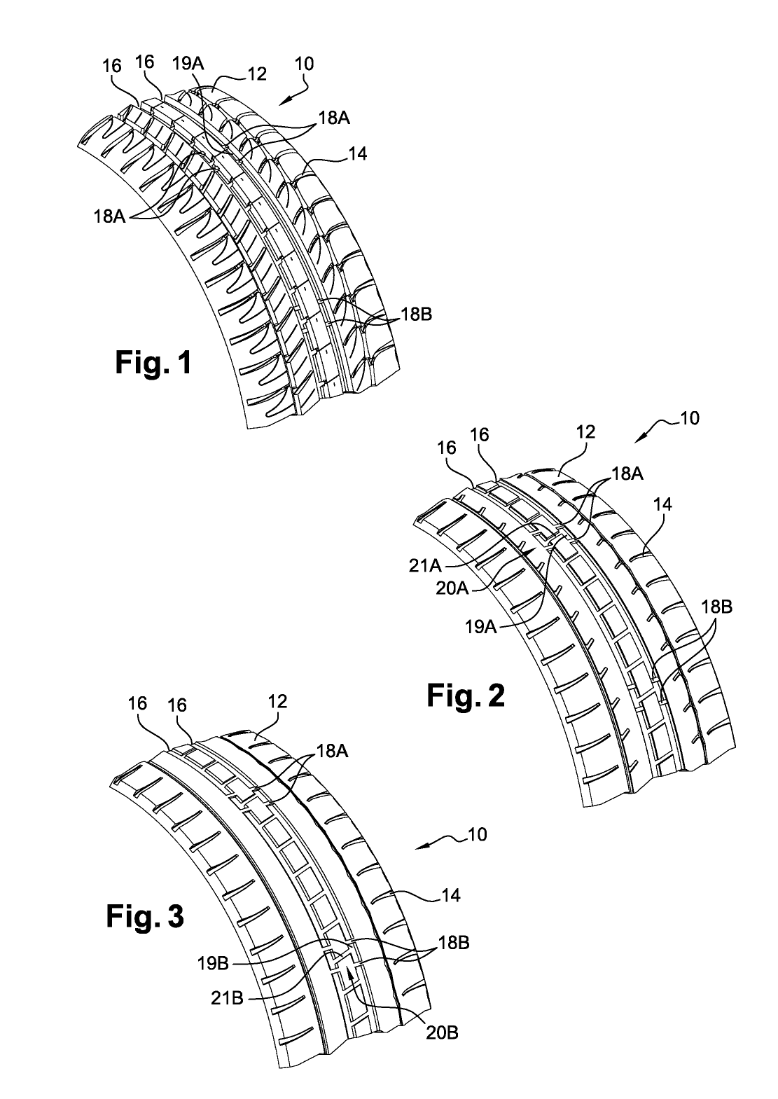

FIG. 1 is a diagram of the tread of a brand new tyre with “descending” sonic pattern according to a first embodiment;

FIGS. 2 and 3 are diagrams of the tread of the tyre represented in FIG. 1, worn beyond respectively first and second wear thresholds;

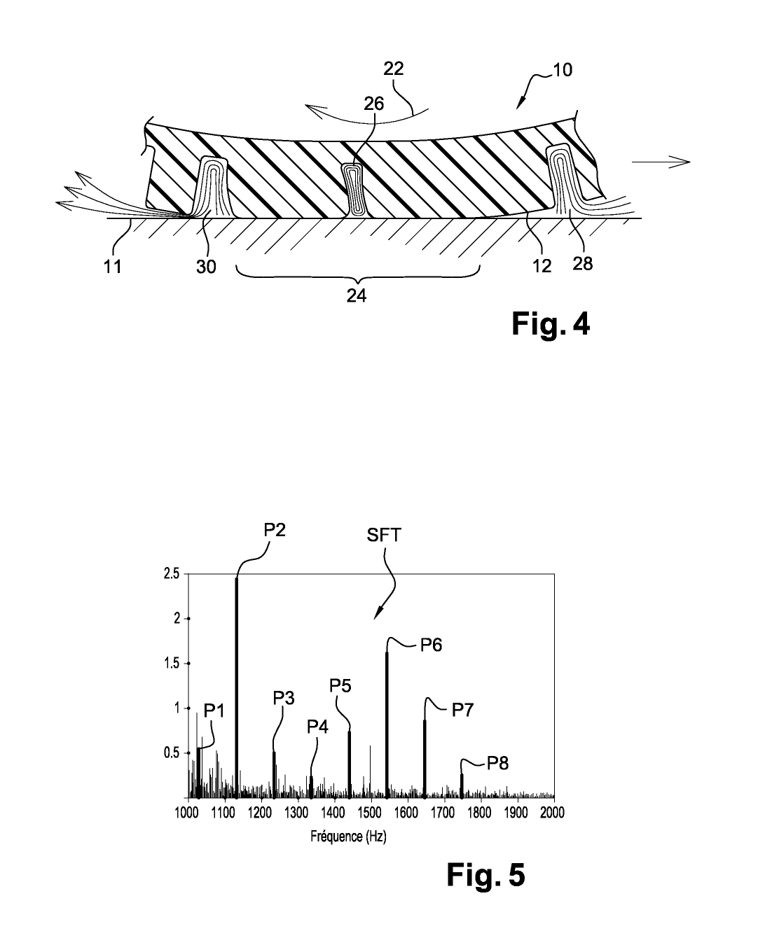

FIG. 4 is a diagram according to a radial section through the tread of the tyre represented in FIG. 3;

FIG. 5 illustrates a frequency spectrum of the acoustic footprint noise of the cavities of the tyre of FIG. 3;

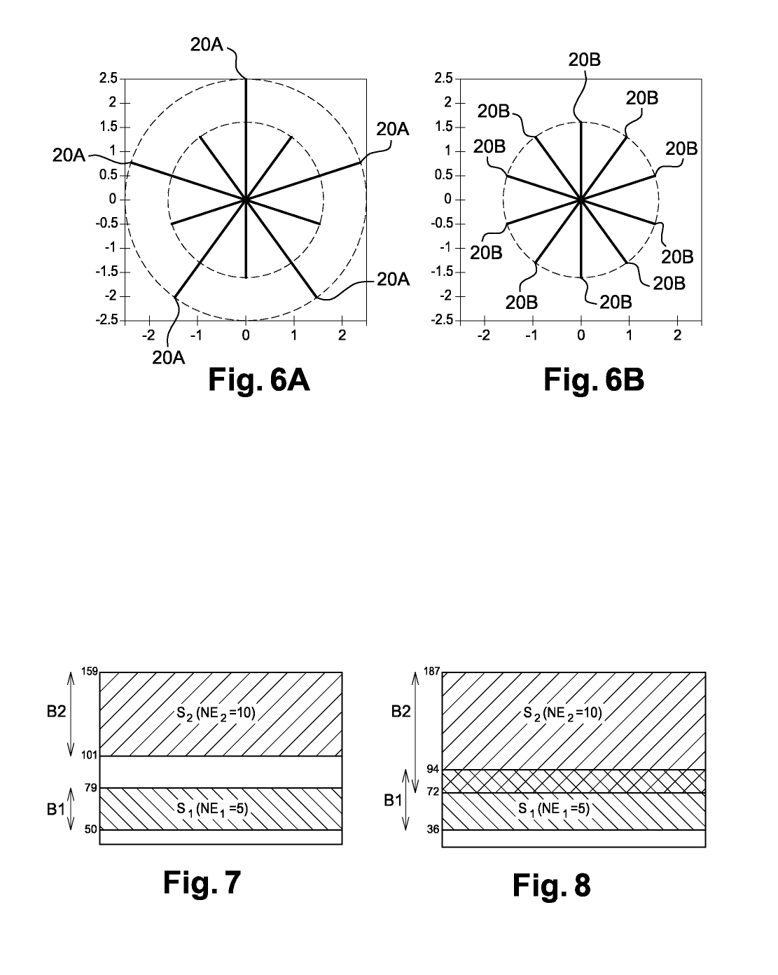

FIGS. 6A and 6B schematically illustrate the distribution of the sets of sonic cavities of the tyre of FIGS. 1 to 3;

FIGS. 7 and 8 represent frequency bands of the noise emitted by the various cavities associated with the various thresholds of the tyre of FIGS. 1 to 3 and 6A and 6B;

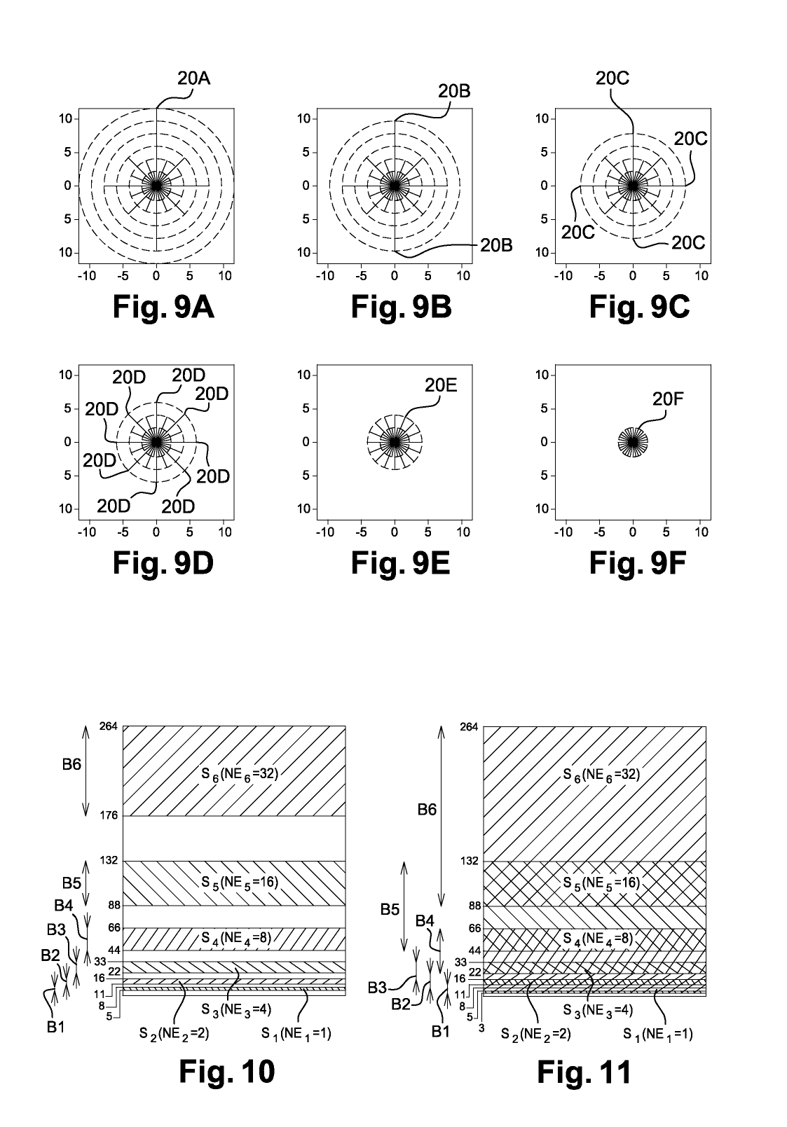

FIGS. 9A to 9F schematically illustrate the distribution of the sets of sonic cavities of a tyre with “descending” sonic pattern according to a second embodiment;

FIGS. 10 and 11 represent frequency bands of the noise emitted by the various cavities associated with the various thresholds of the tyre of FIGS. 9A to 9F;

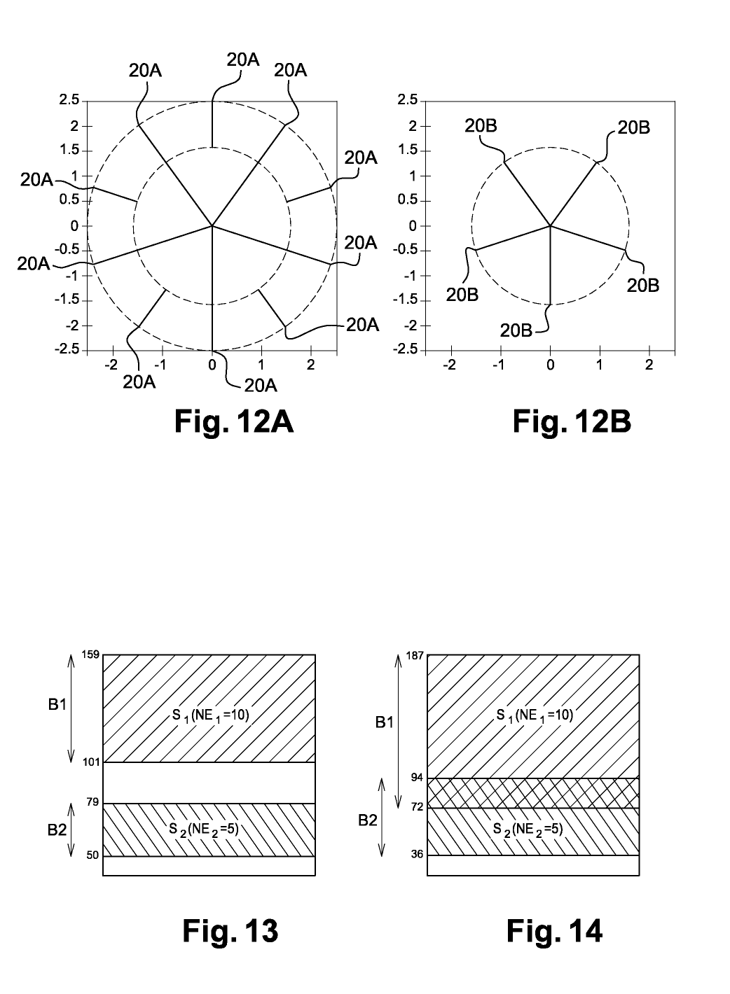

FIGS. 12A and 12B schematically illustrate the distribution of the sets of sonic cavities of a tyre with “ascending” sonic patterns according to a third embodiment;

FIGS. 13 and 14 represent frequency bands of the noise emitted by the various cavities associated with the various thresholds of the tyre of FIGS. 12A and 12B.

Represented in FIG. 1 is part of a tyre, designated by the general reference 10, according to a first embodiment of the invention. The tyre 10 is intended for a passenger vehicle. The tyre 10 is substantially axisymmetric about an axis.

The tyre 10 comprises a tread 12 of substantially cylindrical shape, whose external surface is furnished with sculptures 14. In particular, the tread 12 comprises two circumferential and parallel grooves 16, cut out in the surface of the tyre, of predetermined depth H when the tyre 10 is brand new. The depth H of these grooves 16 is of the order of 8 mm and their width is of the order of 10 mm.

The tyre 10 comprises visual wear gauges (not illustrated) indicating a legal wear threshold SL for the tyre. The depth of each groove corresponding to the threshold SL is fixed at 1.6 mm, thus corresponding to a threshold SL=6.4 mm.

Transversely to the grooves 16, the tread 12 of the tyre comprises a set of ribs 18 made at the bottom of the grooves 16. The set of ribs comprises two types of ribs 18A, 18B each corresponding to at least one predetermined wear threshold S₁, S₂ for the tyre. Each rib 18A, 18B exhibits respectively a first and second predetermined height h₁, h₂ when the tyre is brand new. h₁>h₂ and S₂>S₁ so that each rib of type 18A is associated with the thresholds S₁ and S₂ and each rib of type 18B is associated with the unique threshold S₂. The first threshold S₁ corresponds substantially to 90% of the threshold SL, that is to say h₁=2.5 mm and S₁=5.5 mm. The second threshold S₂ corresponds substantially to 100% of the threshold SL, that is to say h₂=1.6 mm and S₂=6.4 mm. The thresholds S₁, S₂ are represented schematically in FIGS. 6A-6B. FIG. 6A represents the tyre 10 having attained the first wear threshold S₁ but not yet having attained the second wear threshold S₂. FIG. 6B represents the tyre 10 having attained the second wear threshold S₂.

Thus, in this embodiment, the first threshold S₁ corresponds to wear beyond which the tyre exhibits performance that may possibly be degraded on a wet pavement. The second threshold S₂ corresponds, on the other hand, to wear beyond which the tyre no longer complies with the legal requirements.

The distance separating two ribs of the same type is of the order of 20 to 30 millimetres. The volume defined by a groove 16 and two neighbouring ribs 18A, 18B forms respectively a cell 19A, 19B arranged in each circumferential groove 16. Each cell 19A, 19B of each pair of cells 19A, 19B is linked to the other cell of the pair by a transverse channel 21A, 21B. Each pair of cells 19A and the channel 21A form a set consisting of a cavity 20A emerging radially to the exterior of the tyre 10. Likewise, each pair of cells 19B and the channel 21B form a set consisting of a cavity 20B emerging radially to the exterior of the tyre 10. In FIGS. 6A-6B, the cavities 20A, 20B have been shown diagrammatically by dashes. These dashes extend radially over a radial portion showing diagrammatically between which thresholds the corresponding cavities are sonic.

When the tyre is brand new, as is represented in FIG. 1, the height of the ribs 18A, 18B is smaller than the depth of the grooves 16 so that each cavity 20A, 20B comprises a fluidic communication passage situated above the ribs 18A, 18B, that is to say at the top of the ribs 18A, 18B. Thus, even when the tread is in contact with plane and smooth ground 11, the ground 11 does not completely plug the cavities 20A, 20B since the top of the ribs is not in contact with the ground 11. In this case, the various cavities 20A, 20B are in fluidic communication through a constriction channel delimited by the top of the ribs and the ground 11 covering the cavities.

Represented in FIG. 2 is the tyre 10 of FIG. 1 worn beyond the threshold S₁. Stated otherwise, this is a tyre that has rolled numerous kilometres and whose tread 12 has been worn down progressively until it has lost a few millimetres. This tyre 10 is also represented schematically in FIG. 6A where it is seen that, beyond the threshold S₁, the tyre 10 comprises NE₁=5 sets each consisting of a cavity 20A. We therefore have NE₁=N₁=5. During the rotation of the tyre, the cavities 20A are, from the point of view of the rolling tyre, equi-distributed circumferentially over the tread 12 so that each cavity 20A comes periodically into contact with the ground when the tyre rolls at substantially constant speed.

In this instance, the wear of the tread 12, represented in FIG. 2, of the tyre 10 is 6 mm, that is to say greater than the threshold S₁, stated otherwise greater than the distance separating, when the tyre 10 is brand new, the top of the ribs 18A from the surface of the tread 12. Having regard to the wear greater than S₁, the top of the ribs 18A is at the same level as the surface of the tread 12. Thus, the mouth of each cavity 20A is defined by a substantially plane contour made on the tread 12 and the cavities 20A are distinct and separated from the other cavities.

The wear of the tyre is less than the threshold S₂, stated otherwise less than the distance separating, when the tyre 10 is brand new, the top of the ribs 18B from the surface of the tread 12. The top of the ribs 18B is at a lower level that that of the tread at this juncture of the wear.

Beyond the threshold S₁, each cavity 20A exhibits a depth that is less than the height h₁. Here, the depth is less than 2.5 mm and equals 2 mm for 6 mm of wear. The height of each rib 18A is then equal to the depth of each cavity 18A. This height or depth is equal to the difference between the depth of each groove 16 and the wear of the tyre 10.

Because the mouth of each cavity 20A is defined by a substantially plane contour, it is able to be plugged perfectly and hermetically by smooth and plane ground during rolling. Stated otherwise, when the tyre 10 is worn beyond the threshold S₁, each cavity 20A is devised so as to be closed by the ground in a substantially leaktight manner as it passes across the area of contact of the tyre 10 with the ground. Between the thresholds S₁ and S₂, each cavity 20B is not closed by the ground in a leaktight manner on account of the constriction channel delimited by the top of each rib 18B and the ground 11.

Represented in FIG. 3 is the tyre 10 of FIGS. 1 and 2 worn beyond the threshold S₂. This tyre 10 is also represented schematically in FIG. 6B where it is seen that, beyond the threshold S₂, the tyre 10 comprises NE₂=10 sets each consisting of a cavity 20B. We therefore have NE₂=N₂=10.

In this instance, the wear of the tread 12, represented in FIG. 3, of the tyre 10 is 7 mm, that is to say greater than the threshold S₂, and also than the threshold S₁, stated otherwise greater than the distance separating, when the tyre 10 is brand new, the top of the ribs 18B from the surface of the tread 12. Having regard to the wear greater than S₂, the top of the ribs 18B, and also that of the ribs 18A, is at the same level as the surface of the tread 12. Thus, the mouth of each cavity 20B is defined by a substantially plane contour made on the tread 12 and the cavities 20B are distinct and separated from the other cavities. The mouth of each cavity 20A remains unchanged with respect to the mouth obtained beyond the threshold S₁ and before the threshold S₂.

Beyond the threshold S₂, each cavity 20B exhibits a depth that is less than the height h₂. Here, the depth is less than 1.6 mm and equals 1 mm for 7 mm of wear. The height of each rib 18A, 18B is then equal to the depth of each cavity 18A, 18B. This height or depth is equal to the difference between the depth of each groove 16 and the wear of the tyre 10.

Because the mouth of each cavity 20A, 20B is defined by a substantially plane contour, it is able to be plugged perfectly and hermetically by smooth and plane ground during rolling. Stated otherwise, when the tyre 10 is worn beyond the threshold S₂, each cavity 20A, 20B is devised so as to be closed by the ground in a substantially leaktight manner as it passes across the area of contact of the tyre 10 with the ground.

Each cavity 20A, 20B exhibits, beyond the corresponding threshold S₁, S₂, a length of the order of 20 to 30 millimetres corresponding to the circumferential gap between two adjacent ribs 18A, 18B of one and the same cavity.

Such cavities 20A, 20B formed on the surface of the tread 10 of a tyre which, on the one hand, emerge radially to the exterior of the tyre and, on the other hand, are devised so as to be closed hermetically as they pass across the contact area, are termed “sonic”. In this embodiment, each cavity 20A is sonic beyond each threshold S₁, S₂ whereas each cavity 20B is sonic only beyond the threshold S₂. In the example illustrated, the numbers NEᵢ, NEᵢ₋₁ of sets of cavities associated respectively with two consecutive thresholds Sᵢ, Sᵢ₋₁ satisfy NEᵢ₋₁<NEᵢ for i ∈ [2, M] where M is the total number of predetermined thresholds of radial wear and the threshold Sᵢ being greater than the threshold Sᵢ₋₁. Therefore for each value of i ∈ [2, M], we have kᵢ=NEᵢ/NEᵢ₋₁ since NEᵢ/NE₁₋₁>1. A tyre in which NE₂>NE₁ is thus termed a tyre with “descending” sonic pattern. In this embodiment, k₁=NE₂/NE₁=N₂/N₁=2.

The cavities 20A, 20B are arranged so that, beyond each threshold S₁, S₂, the sets of sonic cavities 20A, 20B are equi-distributed circumferentially over the tyre 10. As each set consists of a single cavity, the sonic cavities 20A, 20B are therefore equi-distributed circumferentially over the tyre 10. Furthermore, the tread is devised so that, beyond each threshold S₁, S₂, all the sonic cavities 20A, 20B are identical as is illustrated in FIGS. 6A-6B.

Furthermore, each cavity 20A associated with the threshold S₁ is also associated with the threshold S₂. In the tyre 10, such sonic cavities are nonexistent below the threshold S₁, especially when the tyre is brand new.

Represented in FIG. 4 is a view according to a radial section through a tyre similar to that of FIGS. 1 to 3 while rolling on ground. The dimensions are modified in an arbitrary manner for the clarity of the account. This tyre 10 is in a state in which it is worn beyond the threshold S₂ and consequently comprises a set of sonic cavities 20A, 20B.

The direction of rotation of the tyre 10 while rolling on the ground has been represented by an arrow 22. At a given instant, a part of the tread 12 of the tyre 10 is in contact with the ground. This part in contact is called the contact area 24. The tread 12 is devised so that each sonic cavity 20A, 20B exhibits, as it passes across the area of the contact 24 of the tyre 10 with the ground 11, a contact cross-section which is constant as a function of the wear of the tyre 10.

In the example represented in FIG. 4, the contact area 24 comprises a sonic cavity 26 whose radially exterior mouth is covered by the ground 11. Thus, this sonic cavity 26 is hermetically closed.

The contact area 12 of the tyre also comprises a sonic cavity 28, situated upstream of the closed cavity 26, which is open since its mouth is not in the contact area and is consequently not covered by the ground. During the rolling of the tyre in the direction designated by the arrow 22, the open cavity 28 will progress towards the contact area 24 until its mouth is plugged by the ground 11.

Finally, the tread 12 of the tyre 10 also comprises a cavity 30 situated downstream of the closed cavity 26, with respect to the direction of rotation of the tyre 10. In the example represented in FIG. 4, the downstream cavity 30 represented is open since the ground 11 is not in contact with its mouth. At a previous instant, this cavity 30 was closed since it was located in the zone of the area of contact 24 of the tyre with the ground 11.

Thus, in the course of the rolling of the tyre, a given sonic cavity successively occupies an upstream position 28 in which it is open, and then a position 26 located in the contact area 24 in which it is closed since it is covered by the ground, and then finally an open position 30 again in which it is no longer covered by the ground.

Stated otherwise, the rotation of the tyre causes, for a given cavity, the admission of air into the cavity, the compression of the air contained in the cavity when the latter is closed by the ground in the contact area 24, and then the expansion of the air contained in the cavity during the opening of the latter by separation of the tread from the ground.

This succession of admission/compression/expansion steps gives rise to a characteristic noise, sometimes called hiss or pumping noise resulting from the expansion of the compressed air contained in the cavity. The amplitude and the frequency signature of this noise depend especially on the shape, on the volume and on the number of sonic cavities used. Preferably, the cavities are devised so that this noise is detectable by a user of the motor vehicle or by an electronic device.

Represented in FIG. 5 is a frequency spectrum SFT of the noise generated by the cavities, visible in FIG. 3, associated with the second threshold S₂. A signal of the acoustic footprint noise generated by the cavities 20B is acquired, for example by means of a microphone. A Fourier transform is applied to the signal so as to obtain a raw frequency spectrum. Next, after steps of processing this raw frequency spectrum, especially of filtering, a filtered frequency spectrum is obtained. The frequency spectrum SFT of the noise represented in FIG. 5 comprising several elementary frequency components P1-P8 is thus obtained. The spectrum takes the form of a Dirac comb characterized by the equi-distributed elementary frequency components. Each elementary frequency component is distant from the adjacent frequency component by a substantially constant frequency gap F_{TUS}. In this instance F_{TUS}=120 Hz.

The parameters such as the number of wear gauges, their geometry of installation, the speed of rotation of the tyre or else the dimensions of the tyre, define a reference frequency interval IR to which the frequency F_{TUS} is liable to belong. For a range of passenger vehicle tyres, whose circumference may vary between 1.3 m and 3 m, whose number of gauges may vary between 1 and 10 and, for which the speed of the vehicle may vary between 10 km/h and 130 km/h, the frequency F_{TUS} may vary in the interval IR lying between 1 and 278 Hz. For tyres of heavy goods vehicle type, the interval IR is similar.

Illustrated in FIG. 7 are two frequency bands B1=[50 Hz; 79 Hz] and B2=[101 Hz; 159 Hz] in which is situated F_{TUS} for the noise generated by the cavities associated respectively with each threshold S₁, S₂ for the tyre 10 of FIGS. 1 to 3 which exhibits a rolling circumference of 1.93 m in the brand new state. As calculated hereinabove, k₁=NE₂/NE₁=N₂/N₁=2 so that the minimum value kₘᵢₙ of the values of kᵢ, for i ∈ [2, M] is equal to 2. For each threshold S₁, S₂, the acoustic footprint noise SFT emitted by the cavities 20A and 20B is detected. In order to identify in an unequivocal manner the threshold S₁ associated with the noise generated by the tyre 10, the speed V for detecting the noise is limited to an interval I=]Vₘᵢₙ; Vₘₐₓ]=]70 km/h; 110 km/h] satisfying Vₘₐₓ≦kₘᵢₙ·Vₘᵢₙ. In this case, the bands B1, B2 are disjoint so that for a value of F_{TUS} determined on the basis of the acoustic footprint noise, the cavities 20A or 20B by which the corresponding noise is generated are identified in an unequivocal manner.

Two bands B1=[36 Hz; 94 Hz] and B2=[72 Hz; 187 Hz] have been illustrated in FIG. 8. In this case, the speed interval V in which the noise is detected is I=]Vₘᵢₙ; Vₘₐₓ]=]50 km/h; 130 km/h] and does not satisfy Vₘₐₓ≦kₘᵢₙ·Vₘᵢₙ. The bands B1, B2 exhibit an overlap interval [72 Hz; 94 Hz] so that for values F_{TUS} of this overlap interval, the corresponding noise is generated by the cavities 20A or 20B without it being possible to identify which ones are generating the noise.

A tyre according to a second embodiment has been represented in FIGS. 9A-9F. The tyre 10 is intended for a heavy goods type vehicle. The elements analogous to those designated in the previous figures are designated by identical references.

In contradistinction to the first embodiment, the tyre 10 according to the second embodiment comprises six predetermined thresholds of radial wear S₁-S₆ with NE₁=N₁=2, NE₂=N₂=1, NE₃=N₃=4, NE₄=N₄=8, NE₅=N₅=16 and NE₆=N₆=32 and therefore the following ratios kᵢ: k₁=k₂=k₃=k₄=k₅=k₆=NE₂/NE₁=N₂/N₁=NE₃/NE₂=N₃/N₂=NE₄/NE₃=N₄/N₃=NE₅/NE₄=N₅/N₄=NE₆/NE₅=N₆/N₅=2. As in the first embodiment, the tyre 10 is “descending” sonic pattern tyre.

The depth of the grooves 16 is of the order of 14 millimetres, here 14.3 mm. The depth of each groove corresponding to the threshold SL is fixed at 2 mm, thereby corresponding to a threshold SL=12.3 mm. The set of ribs comprises third, fourth, fifth and sixth types of ribs 18C-18F, in addition to the ribs 18A, 18B. Each rib 18C-18F exhibits respectively a third, fourth, fifth and sixth height h₃, h₄, h₅ and h₆, predetermined when the tyre is brand new. h₁>h₂>h₃>h₄>h₅>h₆ and S₆>S₅>S₄>S₃>S₂>S₁ so that each rib of type 18A is associated with the thresholds S₁-S₆, each rib of type 18B is associated with the thresholds S₂-S₆, each rib of type 18C is associated with the thresholds S₃-S₆, each rib 18D is associated with the thresholds S₄-S₆, each rib 18E is associated with the thresholds S₅ and S₆ and each rib 18F is associated with the threshold S₆ alone. The first threshold S₁ corresponds substantially to 19% of the threshold SL, that is to say h₁=12 mm and S₁=2.3 mm. The second threshold S₂ corresponds substantially to 35% of the threshold SL, that is to say h₂=10 mm and S₂=4.3 mm. The third threshold S₃ corresponds substantially to 51% of the threshold SL, that is to say h₃=8 mm and S₃=6.3 mm. The fourth threshold S₄ corresponds substantially to 67% of the threshold SL, that is to say h₄=6 mm and S₄=8.3 mm. The fifth threshold S₅ corresponds substantially to 84% of the threshold SL, that is to say h₅=4 mm and S₅=10.3 mm. The sixth threshold S₆ corresponds substantially to 100% of the threshold SL, that is to say h₆=2 mm and S₆=12.3 mm.

The various thresholds correspond to various stages of the life of the tyre during which diverse actions must be undertaken so as to distribute the wear over the whole of the tread and thus increase the lifetime of the tyre.

Thus, the threshold S₂ corresponds to wear for which it is possible to swap the tyre on one and the same axle. The threshold S₄ corresponds to wear for which it is possible to return the tyre. The threshold S₅ corresponds to wear for which it is possible to regroove the tyre so as to restore its performance, especially as regards water dispersal.

Just as in the first embodiment, the sets of cavities 20A-20F, here the sonic cavities 20A-20F, are arranged so that, beyond each threshold S₁-S₆, the set(s) of sonic cavities 20A-20F, here the sonic cavities 20A-20F, are equi-distributed circumferentially over the tyre 10.

Furthermore, each cavity 20A associated with the threshold S₁ is also associated with the threshold S₂-S₆, each cavity 20B is associated with the thresholds S₂-S₆, each cavity 20C is associated with the thresholds S₃-S₆, each cavity 20D is associated with the thresholds S₄-S₆, each cavity 20E is associated with the thresholds S₅ and S₆ and each cavity 20F is associated with the threshold S₆ alone.

Illustrated in FIG. 10 are six frequency bands B1=[5 Hz; 8 Hz], B2=[11 Hz; 16 Hz], B3=[22 Hz; 33 Hz], B4=[44 Hz; 66 Hz], B5=[88 Hz; 132 Hz] and B6=[176 Hz; 264 Hz] in which is situated F_{TUS} for the noise generated by the cavities associated respectively with each threshold S₁-S₆ for the tyre 10 of the second embodiment which exhibits a rolling circumference of 3.03 m in the brand new state. As calculated hereinabove, k₁=k₂=k₃=k₄=k₅=k₆−2 so that the minimum value kₘᵢₙ is equal to 2. For each threshold S₁-S₆, the acoustic footprint noise SFT emitted by the cavities 20A-20F is detected. In order to identify in an unequivocal manner the threshold Sᵢ, associated with the noise generated by the tyre 10, the speed V for detecting the noise is limited to an interval I=]Vₘᵢₙ; Vₘₐₓ]=]60 km/h; 90 km/h] satisfying Vₘₐₓ≦kₘᵢₙ·Vₘₘ. In this case, the bands B1-B6 are disjoint so that for a value of F_{TUS} determined on the basis of the acoustic footprint noise, the cavities 20A-20F by which the corresponding noise is generated are identified in an unequivocal manner.

Six frequency bands B1=[3 Hz; 8 Hz], B2=[5 Hz; 16 Hz], B3=[11 Hz; 33 Hz], B4=[22 Hz; 66 Hz], B5=[44 Hz; 132 Hz] and B6=[88 Hz; 264 Hz] have been illustrated in FIG. 11. In this case, the speed interval V in which the noise is detected is I=]Vₘᵢₙ; Vₘₐₓ]=]50 km/h; 130 km/h] and does not satisfy Vₘₐₓ≦kₘᵢₙ·Vₘₘ. The bands B1-B6 exhibit pairwise overlap intervals [5 Hz; 8 Hz], [11 Hz; 16 Hz], [22 Hz; 33 Hz], [44 Hz; 66 Hz] and [88 Hz; 132 Hz] so that for values F_{TUS} of these overlap intervals the corresponding noise is generated by cavities without it being possible to identify which ones are generating the noise.

Represented in FIGS. 12A-12B is a third embodiment of a tyre according to the invention comprising two wear thresholds. The elements analogous to those designated in the previous figures are designated by identical references.

In contradistinction to the previous embodiments, the number of sets of sonic cavities 20A, 20B decreases with the wear of the tyre 10. The numbers NEᵢ, NEᵢ₋₁ of sets of cavities associated respectively with two consecutive thresholds Sᵢ, Sᵢ₋₁ satisfy NEᵢ₋₁>NEᵢ for i ∈ [2, M] where M is the total number of predetermined thresholds of radial wear and the threshold Sᵢ being greater than the threshold Sᵢ₋₁. Therefore for each value of i ∈ [2, M], we have we have kᵢ=NEᵢ₋₁/NEᵢ since NEᵢ₋₁/NEᵢ>1. Such a tyre is termed a tyre with “ascending” sonic pattern. In this embodiment, k₁=NE₁/NE₂=N₁/N₂=2.

In contradistinction to the first embodiment, each sonic cavity 20B associated with the second threshold S₂ is also associated with the first threshold S₁. Only part of the sonic cavities 20A associated with the first threshold S₁ is also associated with the second threshold S₂.

Illustrated in FIG. 13 are two frequency bands B1=[101 Hz; 159 Hz] and B2=[50 Hz; 79 Hz] in which is situated F_{TUS} for the noise generated by the cavities associated respectively with each threshold S₁, S₂ for the tyre 10 of the third embodiment which exhibits a rolling circumference of 1.93 m in the brand new state. As calculated hereinabove, k₁=NE₁/NE₂=N₁/N₂=2 so that the minimum value kₘᵢₙ of the values of kᵢ for i ∈ [2, M] is equal to 2. The interval I=]Vₘᵢₙ; Vₘₐₓ]=]70 km/h; 110 km/h] therefore satisfies Vₘₐₓ≦kₘᵢₙ·Vₘᵢₙ. The bands B1, B2 are disjoint so that for a value of F_{TUS} determined on the basis of the acoustic footprint noise, the cavities 20A or 20B by which the corresponding noise is generated are identified in an unequivocal manner.

Two bands B1=[72 Hz; 187 Hz] and B2=[36 Hz; 94 Hz] have been illustrated in FIG. 14. In this case, the speed interval V in which the noise is detected is I=]Vₘᵢₙ; Vₘₐₓ]=]50 km/h; 130 km/h] and does not satisfy Vₘₐₓ≦kₘᵢₙ·Vₘᵢₙ. The bands B1, B2 exhibit an overlap interval defined by [72 Hz; 94 Hz] so that for values F_{TUS} of this overlap interval, the corresponding noise is generated by the cavities 20A or 20B without it being possible to identify which ones are generating the noise.

The invention is not limited to the embodiments described above.

Furthermore, the tread will be able to comprise more than two grooves and therefore sets of cavities comprising more than two substantially axially aligned cavities, that is to say exhibiting the same azimuth.

The tread will also be able to comprise a single groove. Each cavity will therefore be formed by a cell.

The tread will be able to comprise several grooves and each cavity to comprise a single sonic cell so that two circumferentially successive cavities are situated in two different grooves.

The tread will be able to comprise cavities arranged in each groove, the cavities being substantially aligned axially pairwise without however being linked to one another by a channel. Such cavities will be able to be associated with the same wear threshold or else with two different wear thresholds.

In all these cases, the cavities may have variable or constant contact cross-section and be used equally well with tyres having “ascending” or “descending” sonic patterns.

By way of additional examples of a tyre with descending sonic pattern, it will be possible to utilize tyres with three or four thresholds exhibiting the following characteristics:
NE₁=1, NE₂=2, NE₃=4, NE₄=8.
NE₁=1, NE₂=3, NE₃=6.
NE₁=1, NE₂=2, NE₃=6.
NE₁=2, NE₂=4, NE₃=8.
NE₁=2, NE₂=6, NE₃=12.
NE₁=3, NE₂=6, NE₃=12.

By way of additional examples of a tyre with ascending sonic pattern, it will be possible to utilize tyres with three or four thresholds exhibiting the following characteristics:
NE₁=8, NE₂=4, NE₃=2, NE₄=1.
NE₁=9, NE₂=3, NE₃=1.
NE₁=12, NE₂=6, NE₃=2.

1-15. (canceled)

16. A method for detecting wear of a tyre that includes a tread and that exhibits at least two predetermined thresholds of radial wear, the method comprising steps of:
providing a tyre with a plurality of thresholds Sᵢ, the tyre being structured such that:
beyond each threshold Sᵢ, a tread of the tyre includes NEᵢ sets of at least one sonic cavity associated with that threshold Sᵢ, and
for each threshold Sᵢ, kₘᵢₙ is a minimum value of values of kᵢ for i ∈[2, M], where M is a total number of predetermined thresholds of radial wear, with:
k₁=NEᵢ/NEᵢ₋₁ when, for a value of i ∈ [2, M], NEᵢ/NEᵢ₋₁>1, or
kᵢ=NEᵢ₋₁/NEᵢ when, for the value of i ∈ [2, M], NEᵢ₋₁/NEᵢ>1; and
for each threshold Sᵢ, detecting an acoustic footprint noise emitted by at least one sonic cavity associated with the threshold Sᵢ at a speed V,
wherein, in the step of detecting the acoustic footprint noise, a value of the speed V is limited to an interval I=]Vₘᵢₙ; Vₘₐₓ] satisfying Vₘₐₓ<kₘᵢₙ·Vₘᵢₙ, and
wherein, if a set includes a plurality of sonic cavities, the plurality of sonic cavities of the set are substantially aligned axially with one another.

17. The method according to claim 16, wherein the acoustic footprint noise includes a plurality of elementary frequency components of an acoustic footprint that forms at least part of a Dirac comb.

18. The method according to claim 17, wherein each elementary frequency component of the acoustic footprint noise is distant from at least one adjacent elementary frequency component of the acoustic footprint noise by a frequency gap lying in a reference frequency interval associated with a single threshold Sᵢ.

19. The method according to the claim 18, wherein the predetermined reference frequency interval lies between 1 and 300 Hz.

20. The method according to any one of claims 16-19, wherein each set includes a single sonic cavity.

21. The method according to claim 16, wherein each set includes at least two sonic cavities aligned substantially axially with one another.

22. The method according to claim 16, wherein sets associated with a threshold Sᵢ are arranged such that, beyond that threshold Sᵢ, the sets associated with that threshold Sᵢ are equi-distributed circumferentially over the tyre.

23. The method according to claim 16, wherein, beyond a threshold Sᵢ each sonic cavity corresponding to that threshold Sᵢ emerges radially toward an exterior part of the tyre, and is structured so as to be closed by a ground surface in a substantially leaktight manner as that sonic cavity passes across an area of the contact of the tyre with the ground surface.

24. The method according to claim 16,
wherein the tyre includes:
at least one circumferential groove having a predetermined depth when the tyre is new, and
two ribs oriented transversely at a bottom portion of the groove, the at least two ribs being of a predetermined height when the tyre is new, the predetermined height being substantially equal to a difference between the predetermined depth of the groove and one of the thresholds Sᵢ, and
wherein a distance separating the two ribs is less than a predetermined distance such that, beyond a threshold Sᵢ, a cavity that is formed by the groove and delimited by the two ribs is sonic.

25. The method according to claim 16, wherein kᵢ=NEᵢ/NEᵢ₋₁>1 for any value of i ∈ [2, M].

26. The method according to claim 16, wherein each sonic cavity associated with a given threshold of the plurality of thresholds Sᵢ also is associated with a threshold above the given threshold.

27. The method according to claim 16, wherein kᵢ=NEᵢ₋₁/NEᵢ>1 for any value of i ∈ [2, M].

28. A programmed computer configured to detect wear of a tyre that includes a tread and that exhibits a plurality of thresholds Sᵢ of radial wear, the tyre being structured such that:
beyond each threshold Sᵢ, a tread of the tyre includes NEᵢ sets of at least one sonic cavity associated with that threshold Sᵢ, wherein, if a set includes a plurality of sonic cavities, the plurality of sonic cavities of the set are substantially aligned axially with one another, and
for each threshold Sᵢ, kₘᵢₙ is a minimum value of values of kᵢ for i ∈ [2, M], where M is a total number of predetermined thresholds of radial wear, with:
kᵢ=NEᵢ/NEᵢ₋₁ when, for a value of i ∈ [2, M], NEᵢ/NEᵢ₋₁>1, or
kᵢ=NEᵢ₋₁/NEᵢ when, for the value of i ∈ [2, M], NEᵢ₋₁/NEᵢ>1,
the programmed computer comprising computer code for detecting, for each threshold Sᵢ, an acoustic footprint noise emitted by at least one sonic cavity associated with the threshold Sᵢ at a speed V, wherein, in the detecting of the acoustic footprint noise, a value of the speed V is limited to an interval I=]Vₘᵢₙ; Vₘₐₓ] satisfying Vₘₐₓ<kₘᵢₙ·Vₘᵢₙ.

29. A non-transient computer-readable storage medium storing computer code that, when executed by a computer, causes the computer to detect wear of a tyre that includes a tread and that exhibits a plurality of thresholds Sᵢ of radial wear, the tyre being structured such that:
beyond each threshold Sᵢ a tread of the tyre includes NEᵢ sets of at least one sonic cavity associated with that threshold Sᵢ, wherein, if a set includes a plurality of sonic cavities, the plurality of sonic cavities of the set are substantially aligned axially with one another, and
for each threshold Sᵢ, kₘᵢₙ is a minimum value of values of kᵢ for i ∈[2, M], where M is a total number of predetermined thresholds of radial wear, with:
kᵢ=NEᵢ/NEᵢ₋₁ when, for a value of i ∈ [2, M], NEᵢ/NEᵢ₋₁>1, or
kᵢ=NEᵢ₋₁/NEᵢ when, for the value of i ∈ [2, M], NEᵢ₋₁/NEᵢ>1,
the computer code comprising code that detects, for each threshold Sᵢ, an acoustic footprint noise emitted by at least one sonic cavity associated with the threshold Sᵢ at a speed V, wherein, in the detecting of the acoustic footprint noise, a value of the speed V is limited to an interval I=]Vₘᵢₙ; Vₘₐₓ] satisfying Vₘₐₓ<kₘᵢₙ·Vₘᵢₙ.

30. A method for detecting wear of a tyre that includes a tread and that exhibits a plurality of thresholds Sᵢ of radial wear, the tyre being structured such that:
beyond each threshold Sᵢ, a tread of the tyre includes NEᵢ sets of at least one sonic cavity associated with that threshold Sᵢ, wherein, if a set includes a plurality of sonic cavities, the plurality of sonic cavities of the set are substantially aligned axially with one another, and
for each threshold Sᵢ, kₘᵢₙ is a minimum value of values of kᵢ for i ∈ [2, M], where M is a total number of predetermined thresholds of radial wear, with:
kᵢ=NEᵢ/NEᵢ₋₁ when, for a value of i ∈ [2, M], NEᵢ/NEᵢ₋₁>1, or
k₁=NEᵢ₋₁/NEᵢ when, for the value of i ∈ [2, M], NEᵢ₋₁/NEᵢ>1,
the method comprising steps of:
installing on a first computer connected to a telecommunications network, computer code for detecting, for each threshold Sᵢ, an acoustic footprint noise emitted by at least one sonic cavity associated with the threshold Sᵢ at a speed V, wherein, in the detecting of the acoustic footprint noise, a value of the speed V is limited to an interval I=]Vₘᵢₙ; Vₘₐₓ] satisfying Vₘₐₓ<kₘᵢₙ·Vₘᵢₙ; and
enabling the computer code to be downloaded by a second computer connected to the telecommunications network.
